(19) United States
(12) Patent Application Publication
(10) Pub. No.: US 2024/0383601 A1
(43) Pub. Date: Nov. 21, 2024

(54) WHEEL BRAKE ASSEMBLY FOR AIRCRAFT

(71) Applicant: DAWIN FRICTION, Ltd., Incheon (KR)

(72) Inventors: Deuk-Soo KANG, Seoul (KR); Beom-Joo LEE, Incheon (KR); Young-Chan JU, Seongnam (KR); Se-Yong LEE, Incheon (KR)

(21) Appl. No.: 18/199,293

(22) Filed: May 18, 2023

(51) Int. Cl. B64C 25/44

(52) U.S. Cl. CPC B64C 25/44; F16D 55/36; F16D 65/18; F16D 2121/02; F16D 2121/24

(57) ABSTRACT

The present disclosure relates to a wheel brake assembly for an aircraft installed in a landing gear assembly between an axle and a tire mounted on a rim to apply a braking force to a wheel. The wheel brake assembly comprises a carrier plate fixedly mounted on the axle; a brake actuator disposed on the carrier plate to generate a braking force; a disc pack including a plurality of discs operated by the brake actuator to stop the rotating wheel against the ground; and a torsion tube connected to the carrier plate and surrounding the disc pack between the rim and the axle.

### BACKGROUND OF THE DISCLOSURE

### Technical Field

The present disclosure relates to a wheel brake assembly for an aircraft, and more particularly, to a wheel brake assembly for an aircraft which has a simple configuration and may perform an efficient braking operation while driving on the ground.

### Description of Related Art

A wheel brake assembly is mounted on an axle of a landing gear of an aircraft to decelerate the aircraft when landing on the main runway or to decelerate or stop the aircraft while driving on the auxiliary runway.

In general, the wheel brake assembly is classified into a caliper type applied for a small braking load and a disc type applied for a large braking load. The disc-type wheel brake assembly has a structure provided with a disc pack in which a plurality of rotor discs and a plurality of stator discs are alternately assembled, and the present invention is described and limited to the disc-type wheel brake assembly hereinbelow.

The disc-type wheel brake assembly has a brake actuator for applying a braking force to the disc pack, and the brake actuator is configured to apply pressure to the disc pack to perform a braking operation to stop rotation of a wheel with respect to the axle.

The brake actuator includes a hydraulic actuator which presses a pusher against the disc pack using a pressure oil or an electromechanical (or electric) actuator which uses a rotational force of a motor to presses the pusher against the disc pack.

The electromechanical actuator has only a difference in specifications according to the required braking force, but it has a similar basic configuration and operation for large or small aircraft. A variety of wheel brake assemblies has been developed and applied in the aerospace industry in which various technologies are implemented for required functions or characteristics.

Recently, interests in an Urban Air Mobility (UAM) using drones or small aircrafts have been increasing to relieve traffic congestion problems in large cities. For implementing the UAM, several technologies for UAM structures and methods for operating an electric vertical take-off and landing (eVTOL), personal air vehicles (PAV) and the like have been proposed.

The UAM is designed to operate in a vertical take-off and landing manner due to using the limited urban space, in which a small UAM carrying 5 or less people including a pilot or a medium-sized UAM carrying about 20 people may be considered. Such the UAM requires a brake operation to decelerate or stop itself while traveling to a desired place, if necessary, in connection with takeoff and landing operations.

For such the brake operation, the wheel brake assembly should be installed in the landing gear assembly. The wheel brake assembly for the UAM may be constructed by miniaturizing the design of a disc-type electromechanical or electric brake assembly which has been applied to an existing general commercial aircraft.

Since the UAM has a smaller body weight and less braking load (torque) than the commercial aircraft. For example, in the case of a 5 to 20-seater UAM, a disc type or a caliper type wheel brake assembly which may generate a dynamic braking force ranging from about 12,000N to 30,000N is provided on the axle to perform the required braking operation.

Accordingly, there has been a need to develop a technology for a wheel brake assembly which may be applied to a small or medium-sized UAM, has a simple and lightweight structure, is easy to manufacture, and performs an efficient and reliable braking operation.

### SUMMARY OF THE DISCLOSURE

The present disclosure has been made in efforts to solve the problems of the related art and the present disclosure is directed to providing a wheel brake assembly which may be applied to a small or medium-sized UAM, has a simple and lightweight structure, is easy to manufacture, and performs a reliable braking operation.

The wheel brake assembly for an aircraft (hereinafter referred to as a “brake assembly”) according to an exemplary embodiment of the present disclosure may be installed in a landing gear assembly between an axle and a tire mounted on a rim to apply a braking force to a wheel, comprising a carrier plate fixedly mounted on the axle; a brake actuator disposed on the carrier plate to generate a braking force; a disc pack including a plurality of discs operated by the brake actuator to stop the rotating wheel against the ground; and a torsion tube connected to the carrier plate and surrounding the disc pack between the rim and the axle.

The carrier plate may be a polygonal-shaped plate and may be formed with a hole in the center of the carrier plate through which the axle passes.

The carrier plate may be a rectangular plate wherein a pair of brake actuators may be installed facing each other on a short side of the carrier plate.

The carrier plate may be a Y-shaped plate where brake actuators each may be installed adjacent to each vertex of the Y-shaped carrier plate.

The carrier plate may be a cross-shaped plate where brake actuators each may be installed on each protruded portion of the cross-shaped carrier plate.

The brake actuator may include an electric motor, and wherein a rotational force of the electric motor may induce a linear movement of a ball screw through a gear train to press the disc pack via a pusher.

The brake actuator may include a hydraulic motor, wherein a rotational force of the hydraulic motor may induce a linear movement of a ball screw through a gear train to press the disc pack via a pusher.

The disc pack may include a plurality of first discs spline-coupled to the rim to rotate together with the axle and a plurality of second discs spline-coupled to the torsion tube as being fixed against the axle, and wherein the first and second discs may be alternately arranged.

Each of the plurality of first discs may have a plurality of first protrusions formed on an outer circumferential surface thereof at predetermined intervals, and the plurality of first protrusions may be spline-coupled to first groove portions formed on an inner circumferential surface of the rim at predetermined intervals.

Each of the plurality of second discs may have a plurality of second protrusions formed on an inner circumferential surface at predetermined intervals, and the plurality of second protrusions may be spline-coupled to second groove portions formed on an outer circumferential surface of the torsion tube at predetermined intervals.

The disc pack may further include a pressure plate at a front end to facilitate a braking operation while receiving a pressing force from the pusher.

The disc pack may further include a thrust plate at a rear end to facilitate a braking operation while receiving a reaction force from the torsion tube.

The plurality of first and second discs may be made of stainless steel and friction pads may be attached to one or both side surfaces of the first and second discs.

The first and second discs may be made of a carbon composite material, and wherein friction pads may be attached to one or both side surfaces of the first and second discs.

A wheel brake assembly for an aircraft according to another exemplary embodiment of the present disclosure installed between an axle and a rim of a landing gear assembly to apply a braking force to a wheel, comprising: a square-shaped carrier plate fixedly mounted on the rotating axle; a pair of brake actuators disposed on the carrier plate to generate a braking force; a disc pack including a plurality of first discs and spline-coupled to the rim and a plurality of second discs and spline-coupled to a torsion tube in which the plurality of first and second discs are alternately arranged and operated by the brake actuator to stop the rotating wheel against the ground; and a pusher connected to the brake actuator to transmit a pressing force to the disc pack, wherein the first disc may have a plurality of first protrusions formed on an outer circumferential surface at predetermined intervals and spline-coupled to first groove portions formed on an inner circumferential surface of the rim at predetermined intervals, and wherein the second disc may have a plurality of second protrusions formed on an inner outer circumferential surface at predetermined intervals and spline-coupled to second groove portions formed at predetermined intervals on an outer circumferential surface of the torsion tube.

The pair of brake actuators may be installed facing each other on a short side of the carrier plate.

Each of the brake actuators may include an electric motor whose rotational force of the electric motor may induce a linear movement of a ball screw through a plurality of gear trains to press the disc pack via the pusher.

Each of the brake actuators includes a hydraulic motor, and wherein the rotational force of the hydraulic motor may induce a linear movement of the ball screw through a plurality of gear trains to press the disc pack via a pusher.

The disc pack may further include a pressure plate at a front end and a thrust plate at a rear end to facilitate a braking operation by receiving a pressing force from the pusher in conjunction with a reaction force transmitted from the torsion tube.

The plurality of first and second discs may be applied with friction pads attached to one or both side surfaces of the discs.

The first and second discs may be applied with friction pads attached to one or both side surfaces of the discs.

The wheel brake assembly for an aircraft according to the present disclosure configured as described above may have the following advantages.

First, the brake actuators according to the present disclosure are installed facing each other to the carrier plate, so a balanced braking force may be applied to the disc pack at two, three, or four points to obtain a stable and reliable braking operation.

Second, since the carrier plate and the brake actuator may be coupled with bolts and nuts, it is possible to easily separate and replace a failed brake actuator from the wheel brake assembly.

The carrier plate may be formed in a simple and lightweight structure which can be easily fabricated from a rectangular or triangular plate.

The information included in this Background of the present disclosure is only for enhancement of understanding of the general background of the present disclosure and may not be taken as an acknowledgement or any form of suggestion that this information forms the prior art already known to a person skilled in the art.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not intended to limit the present disclosure. In the figures, reference numbers refer to the same or equivalent parts of the present invention throughout the several figures of the drawing.

FIG. 1 is a schematic cross-sectional view showing that a wheel brake assembly for an aircraft according to an exemplary embodiment of the present disclosure is disposed between an axle and a rim.

FIG. 2 is a perspective view of a wheel brake assembly for an aircraft according to an exemplary embodiment of the present disclosure shown in the direction A of FIG. 1;

FIG. 3 is a rear perspective view of FIG. 1.

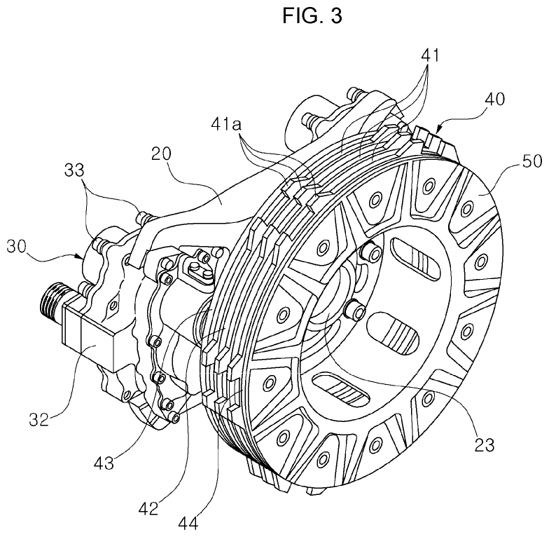

FIG. 4 is a cross-sectional view schematically showing a brake actuator of a wheel brake assembly for an aircraft according to an exemplary embodiment of the present disclosure.

FIG. 5 is a front view of a wheel brake assembly for an aircraft according to another exemplary embodiment of the present disclosure.

FIG. 6 is a front view of a wheel brake assembly for an aircraft according to still another exemplary embodiment of the present disclosure.

### DESCRIPTION OF SPECIFIC EMBODIMENTS

Reference will now be made in detail to various embodiments of the present disclosure(s), examples of which are illustrated in the accompanying drawings and described below. While the present disclosure(s) will be described in conjunction with exemplary embodiments of the present disclosure, it should be understood that this is not intended to limit the present disclosure to the specific embodiments and includes all modifications, equivalents, and substitutes included in the spirit and scope of the present disclosure. In describing the embodiments of the present disclosure, where it has been determined that a detailed description of related known technologies may obscure the gist of the present disclosure, a detailed description thereof has been omitted. When a component, device, element, or the like, of the present disclosure, is described as having a purpose or performing an operation, function, or the like, the component, device, or element should be considered herein as being “configured to” meet that purpose or to perform that operation or function.

In describing the present invention, specific descriptions of known functions or configurations of the electromechanical or electric brake actuator will be omitted or briefly described to the extent necessary to clarify the gist of the present disclosure.

A wheel brake assembly (hereinafter referred to as a “brake assembly”) 100 for an aircraft according to an exemplary embodiment of the present disclosure may be installed in a landing gear assembly 1 between an axle 2 and a tire 3 mounted on a rim 4 to apply a braking force to a wheel 5.

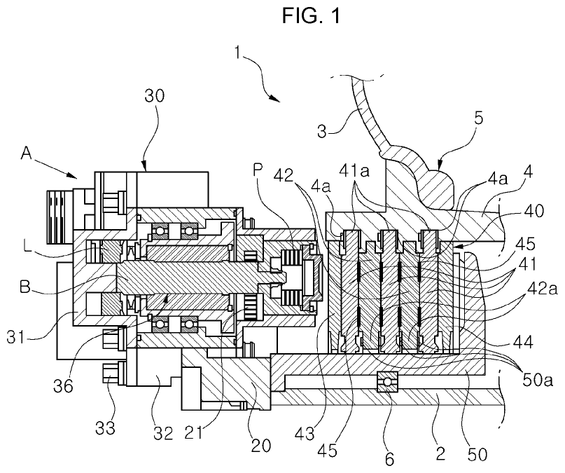

As shown in FIG. 1, the brake assembly 100 may include a carrier plate 20 fixedly mounted on the axle 2; a brake actuator 30 disposed on the carrier plate 20 to generate a braking force; a disc pack 40 including a plurality of discs operated by the brake actuator 30 to stop the rotating wheel 5 against the ground; and a torsion tube 50 connected to the carrier plate 20 and surrounding the disc pack 40 between the axle 2 and the rim 4.

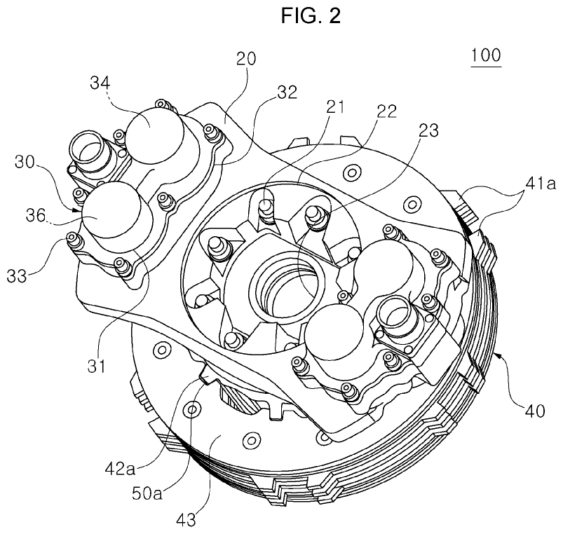

The carrier plate 20 may have a polygonal shape manufactured by pressing or forging with a plate member. The carrier plate 20, for example, may be a square-shaped plate as shown in FIG. 2, and may be made of a steel material such as a stainless steel. However, as a modified example of the present disclosure, the carrier plate 20 may be made of a synthetic resin material such as plastic to reduce weight.

Referring to FIG. 2, the carrier plate 20 may be coupled with the disc pack 40 at a rear surface thereof with a bolt 21 which is fastened at a circular recess portion 22. The recess portion 22 may be formed with a hole 23 at a center thereof through which the axle 2 is rotatably coupled.

The brake actuators 30 in pair, as shown in FIG. 2, may be installed facing each other on a short side of the carrier plate 20.

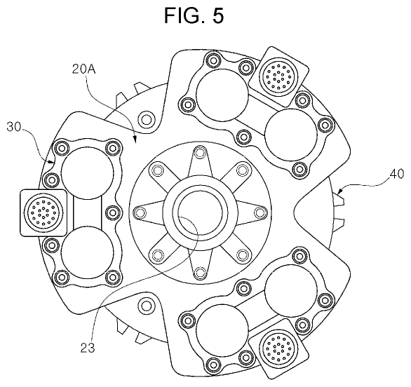

However, as a modified embodiment of the present disclosure to increase the braking force, if necessary, a Y-shaped carrier plate 20A as shown in FIG. 5 may be applied. In this case, the brake actuator 30 may be installed adjacent to each vertex of the carrier plate 20A.

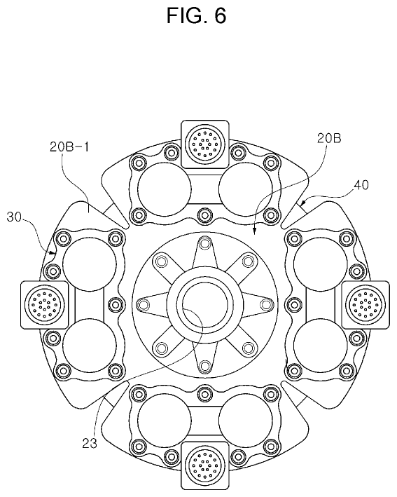

In addition, as a modification of the present invention, when a larger braking force is required as in a medium-sized UAM, a cross-shaped carrier plate 20B as shown in FIG. 6 may be applied. At this time, the brake actuators 30 may be installed one by one on each protrusion portion 20B-1 of the cross-shaped carrier plate 20B.

However, the shape of the carrier plate 20 of the present disclosure is not limited to the above, and may be further modified into a polygonal or circular shape as needed.

Hereinafter, for convenience of description, the present disclosure is directed to a brake assembly 100 comprising a pair of brake actuators 30 installed opposite to each other in the rectangular carrier plate 20 as shown in FIG. 2

The brake actuator 30 may be in a structure preferably using an electric motor, and basic configurations and operations of an electromechanical or electric brake actuator employed with the electric motor are well known in the art. Accordingly, a detailed description of the electromechanical or electric brake actuator will be omitted or briefly described within the scope necessary for description of the present invention.

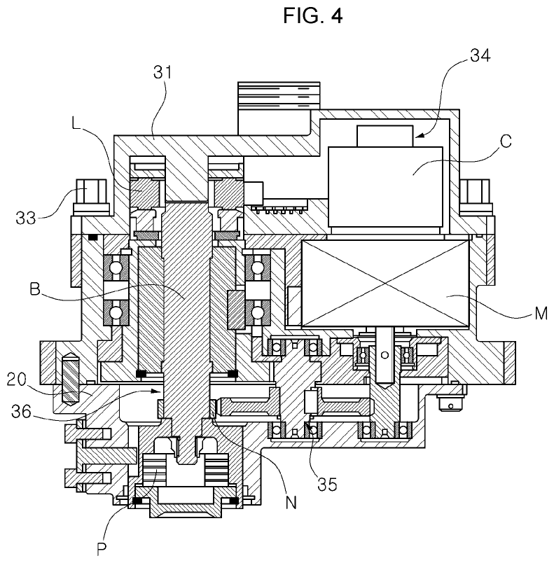

As shown in FIGS. 1 and 4, the brake actuator 30 may be accommodated in a housing 31 and detachably coupled to the carrier plate 20 with bolts 33 via a mounting plate 32. The brake actuator 30 having a failure may be easily separated and replaced from the carrier plate 20.

The brake actuator 30 may include a motor unit 34 which generates a rotational force by receiving electricity, a power transmission unit 35 driven by the rotational force of the motor unit 34, and a pressing unit 36 which generates a linear displacement from the rotational force for pressing the disc pack 40 to cause a braking operation.

The motor unit 34, in general, may include an electric motor M, a motor controller C for driving or stopping the electric motor M, and the like.

The power transmission unit 35 may include a gear train consisting of a plurality of spur gears which transmits the rotational force of the electric motor M to the pressing unit 36.

The pressing unit 36 may include a ball screw (B) configured to generate a linear displacement by receiving the rotational force transmitted from the power transmission unit 35, a load cell (L) configured to measure a load transmitted by the braking operation and to output a signal to a motor controller (C) to control the motor (M), and a piston or pusher (P) coupled to a distal end of the ball screw (B) and configured to advance or retract for pressing or releasing the disc pack (40).

The disc pack 40 may include a plurality of first discs, i.e., rotor discs 41 spline-coupled to the rim 4 to rotate together with the axle 2 and a plurality of second discs, i.e., stator discs 42 spline-coupled to the torsion tube 50 as being fixed against the axle 2, and wherein the first and second discs 41 and 42 may be alternately arranged.

Each of the plurality of first discs 41 may have a plurality of first protrusions 41a formed on an outer circumferential surface thereof at predetermined intervals and spline-coupled to first groove portions 4a formed on an inner circumferential surface of the rim 4 at predetermined intervals.

In addition, each of the plurality of the second discs 42 may have a plurality of second protrusions 42 formed on an inner circumferential surface at predetermined intervals and spline-coupled to second groove portions 50a formed on an outer circumferential surface of the torsion tube 50 at predetermined intervals.

The disc pack 40 may further include a pressure plate 43 at a front end to facilitate a braking operation while receiving a pressing force from the pusher P. In addition, the disc pack 40 may further include a thrust plate 44 at a rear end to facilitate a braking operation while receiving a reaction force transmitted from the torsion tube 50.

The plurality of first and second discs 41 and 42 may be made of stainless steel and friction pads 45 may be attached to one or both side surfaces of the first and second discs 41 and 42.

Meanwhile, as a modified example of the present disclosure, the first and second discs 41 and 42 may be made of a carbon composite material, thereby reducing the weight of the brake assembly 100. Likewise, friction pads 45 may be attached to one or both side surfaces of the first and second discs 41 and 42.

Hereinafter, the braking operation of the wheel brake assembly 100 for the aircraft according to an exemplary embodiment of the present disclosure described above will be described with reference to FIGS. 1 and 4.

When the pilot operates a brake pedal (not shown) or a brake lever (not shown) to stop a UAM while driving the UAM to a desired position, a control signal from a motor controller C may be applied to a motor unit 34 of the brake actuator 30 such that an electric motor M provided in the motor unit 34 may rotate in a forward direction.

The rotational force of the electric motor M may be transmitted to the ball screw B via the nut N of the pressing unit 36 through the gear train consisting of the plurality of spur gears of the power transmission unit 35, causing a linear displacement of the ball screw B. Therefore, the ball screw B may advance to a braking position toward the disc pack (40) and the pusher (P) coupled to the front end of the ball screw B may exert a pressing force on the pressure plate (43) of the disc pack (40) as shown in FIG. 1.

In other words, a pair of the brake actuators 30 installed opposite to the carrier plate 20, as shown in FIG. 2, may apply the pressing force to the pressing plate 43 at two opposing points thereof. Accordingly, the pressing force of the pressure plate 43 may be exerted on the plurality of first discs 41 spline-coupled to the rim 4 and rotating together with the axle 2 and on the plurality of second discs 42 spline-coupled to the torsion tube 50 in conjunction with the reaction force exerted by the torsion tube 50 via the thrust plate 44.

Accordingly, the friction pads 45 provided between the plurality of first and second discs 41 and 42 contact each other to generate the frictional force and to perform a braking operation to stop the wheel 5 on the ground.

On the other hand, after the wheel 5 of the UAM is stopped with respect to the ground as described above, when the pilot releases the brake pedal or lever, another control signal is applied to the motor unit 34 from the motor controller C to operate the electric motor M in a rearward direction. Accordingly, the electric motor M may rotate in reverse to allow a release operation to be performed in the opposite direction to the above.

That is, the ball screw (B) may retreat from the braking position to a releasing position via the power transmission unit 35 by a reverse rotation of the electric motor (M). Accordingly, the pusher P coupled to the front end of the ball screw (B) may be separate from the pressing plate 43 of the disc pack 40 to release the pressing force thereon. Then, the contact of the friction pad 45 between the plurality of first and second discs 41 and 42 is removed, such that the braking operation is released to enable the wheel 5 to freely rotate on the ground.

In the above exemplary embodiment, it has been described that the electric motor M is used as the brake actuator 30, but as a modification of the present disclosure, a hydraulic motor (not shown) may be applied for the brake actuator 30. Here, the rotational force of the hydraulic motor may be applied to a gear train consisting of the plurality of spur gears and converted into a linear displacement via the ball screw to perform an operation of pressing or releasing the disc pack via the pusher may be almost the same as the described above, the description thereof will be omitted.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A wheel brake assembly for an aircraft installed in a landing gear assembly between an axle and a tire mounted on a rim to apply a braking force to a wheel, comprising:
a carrier plate fixedly mounted on the axle;
a brake actuator disposed on the carrier plate to generate a braking force;
a disc pack including a plurality of discs operated by the brake actuator to stop the rotating wheel against the ground; and
a torsion tube connected to the carrier plate and surrounding the disc pack between the rim and the axle.

2. The wheel brake assembly of claim 1, wherein the carrier plate is a polygonal-shaped plate and formed with a hole in the center of the carrier plate through which the axle passes.

3. The wheel brake assembly of claim 2, wherein the carrier plate is a rectangular plate wherein a pair of brake actuators is installed facing each other on a short side of the carrier plate.

4. The wheel brake assembly of claim 2, wherein the carrier plate is a Y-shaped plate where brake actuators each is installed adjacent to each vertex of the Y-shaped carrier plate.

5. The wheel brake assembly of claim 2, wherein the carrier plate is a cross-shaped plate wherein brake actuators each is installed on each protruded portion of the cross-shaped carrier plate.

6. The wheel brake assembly of claim 1, wherein the brake actuator include an electric motor, and wherein a rotational force induces a linear movement of a ball screw through a gear train to press the disc pack via a pusher.

7. The wheel brake assembly of claim 1, wherein the brake actuator include a hydraulic motor, and wherein a rotational force of the hydraulic motor induces a linear movement of a ball screw through a gear train to press the disc pack via a pusher.

8. The wheel brake assembly of claim 1, wherein the disc pack includes a plurality of first discs spline-coupled to the rim to rotate together with the axle and a plurality of second discs spline-coupled to the torsion tube as being fixed against the axle, and wherein the first and second discs are alternately arranged.

9. The wheel brake assembly of claim 8, wherein each of the plurality of first discs has a plurality of first protrusions formed on an outer circumferential surface thereof at predetermined intervals and the plurality of first protrusions is spline-coupled to first groove portions formed on an inner circumferential surface of the rim at predetermined intervals, and
wherein each of the plurality of second discs has a plurality of second protrusions formed on an inner circumferential surface at predetermined intervals and the plurality of second protrusions is spline-coupled to second groove portions formed on an outer circumferential surface of the torsion tube at predetermined intervals.

10. The wheel brake assembly of claim 8, further comprising a pressure plate at a front end of the disc pack to facilitate a braking operation while receiving a pressing force from the pusher.

11. The wheel brake assembly of claim 10, further comprising a thrust plate at a rear end of the disc pack to facilitate a braking operation while receiving a reaction force from the torsion tube.

12. The wheel brake assembly of claim 8, wherein the plurality of first and second discs is made of stainless steel and friction pads are attached to one or both side surfaces of the first and second discs

13. The wheel brake assembly of claim 8, wherein the plurality of first and second discs is made of a carbon composite material, and wherein friction pads are attached to one or both side surface of the first and second discs

14. A wheel brake assembly for an aircraft installed between an axle and a rim of a landing gear assembly to apply a braking force to a wheel, comprising:
a square-shaped carrier plate fixedly mounted on the rotating axle;
a pair of brake actuators disposed on the carrier plate to generate a braking force;
a disc pack including a plurality of first discs spline-coupled to the rim and a plurality of second discs spline-coupled to a torsion tube in which the plurality of first and second discs are alternately arranged and operated by the brake actuator to stop the rotating wheel against the ground; and
a pusher connected to the brake actuator to transmit a pressing force to the disc pack,
wherein the first disc has a plurality of first protrusions formed on an outer circumferential surface at predetermined intervals and spline-coupled to first groove portions formed on an inner circumferential surface of the rim at predetermined intervals, and wherein the second disc has a plurality of second protrusions formed on an inner outer circumferential surface at predetermined intervals and spline-coupled to second groove portions formed at predetermined intervals on an outer circumferential surface of the torsion tube.

15. The wheel brake assembly of claim 14, wherein a pair of brake actuators is installed facing each other on a short side of the carrier plate.

16. The wheel brake assembly of claim 15, wherein each of the brake actuators includes an electric motor whose rotational force of the electric motor induces a linear movement of a ball screw through a plurality of gear trains to press the disc pack via the pusher.

17. The wheel brake assembly of claim 15, wherein each of the brake actuators includes a hydraulic motor whose rotational force of the hydraulic motor induces a linear movement of a ball screw through a plurality of gear trains to press the disc pack via the pusher.

18. The wheel brake assembly of claim 16, wherein the disc pack further includes a pressure plate at a front end and a thrust plate at a rear end to facilitate a braking operation by receiving a pressing force from the pusher in conjunction with a reaction force transmitted from the torsion tube.

19. The wheel brake assembly of claim 18, wherein the plurality of first and second discs is made of stainless steel and friction pads are attached to one or both side surfaces of the first and second discs

20. The wheel brake assembly of claim 18, wherein the plurality of first and second discs is made of a carbon composite material stainless steel to reduce the weight of the brake assembly, and wherein friction pads are attached to one or both side surface of the first and second discs
